(19) United States
(12) Patent Application Publication
(10) Pub. No.: US 2023/0382297 A1
(43) Pub. Date: Nov. 30, 2023

(54) VEHICLE SAFETY CHECK REMINDER MIRROR COVER

(71) Applicant: Murray Scott THOMSON, Beaumont (CA)

(72) Inventor: Murray Scott THOMSON, Beaumont (CA)

(21) Appl. No.: 17/804,688

(22) Filed: May 31, 2022

(51) Int. Cl. B60Q 3/258

(52) U.S. Cl. CPC B60Q 3/258

(57) ABSTRACT

The disclosure relates to a cover that can be slipped over a mirror of any vehicle. The cover is small, light, compact and easy to carry. The cover acts as a reminder to the driver when they return to the vehicle, that they are required to complete a circle check of their vehicle to alert them of any potential hazards before backing up or driving away.

### FIELD OF THE INVENTION

The present invention relates generally to the field of specifically to devices designed to remind drivers to conduct a vehicle walk-around check prior to departure, specifically to mirror covers, more specifically to rear view mirror covers having a reflective element.

### BACKGROUND

Any discussion of the related art throughout the specification should in no way be considered as an admission that such related art is widely known or forms part of common general knowledge in the field.

U.S. Design No. 550,457 (Schlegel) illustrates a cover for a vehicle mirror. The cover appears to be fabricated from a sleeve of material that does not conform to the shape or size of the mirror. It also does not have a reflective element.

U.S. Design No. 878,276 (Rojas) illustrates a vehicle mirror cover. The cover appears to be fabricated from a sleeve of material that does not conform to the shape or size of the mirror. It has a means of securing the cover to the mirror, but it does not have a reflective element.

U.S. Application No. 2015/0328968 (Barber) discloses a side view mirror cover. The cover for a side view mirror is adapted to prevent precipitation such as snow or ice from accumulating thereon. The cover includes a pouch having a closed end, and open end, and an interior volume. The cover is sized so as to fit securely onto the side view mirror and fully encloses the same. The open end includes an elastic element therearound for use in securing the pouch onto a side view mirror, so that the pouch does not fall or slip off of the side view mirror. The pouch may be transparent and waterproof. Further, the pouch may include one or more layers, wherein an inner layer is insulative and an outer layer is waterproof. In this way, the present invention prevents precipitation from accumulating on the side view mirror. Again, the cover does not conform to the shape or size of the mirror, nor does it have a reflective element.

U.S. Pat. No. 6,003,996 (Furst) discloses a cap for external side view mirror of a motor vehicle. The cap for an external side view mirror for a motor vehicle which facilitates the ability of an observer to determine the position of the vehicle. To accomplish this, a light-reflecting strip or triangular pyramidal reflector prisms, for example, are applied to the cap. The cap, however, is fixed to the rear of the mirror by clamp means to a mounting plate of the external mirror of a motor vehicle, by means of a catch finger formed on the inner side of the cap. It is not therefore intended to be removed each time the vehicle is parked.

U.S. Design No. 662,030 (Corley) illustrated a vehicle mirror cover. The cover appears to conform to the shape of the mirror. It is not clear is the cover is removed when the vehicle is driven, or what is the function of the cover. It appears to be fuzzy, so it could be to protect the mirror from ice and snow, or it could just be to display a logo.

U.S. Design No. 631818 (Seale) illustrates a mirror sock. The sock is designed to cover the rear of the mirror. The sock can be secured to the surrounding edges of the mirror such that the mirror is exposed, the function possibly being to prevent stone chips. The sock does not appear to have a reflective element.

U.S. Design No. 653,192 (Lewis) illustrated a mirror glove. The glove also appears to be designed to cover the rear of the mirror. The glove can be secured to the surrounding edges of the mirror such that the mirror is exposed, the function possibly being to prevent stone chips. The glove does not appear to have a reflective element.

CA Patent No: 2,823,359 (Patterson) discloses a vehicle pre-check circle checking tool. The transformable tool assists truck drivers to perform their pre-trip circle checking. It comprises a “C” hook, a push rod, control housing, an automatic locking system, a cylindrical body and a pulling means. The “C” hook is configured to intermediate one end of the push rod permanently, the push rod second ending enclosed within the cylindrical body. The control housing encloses the automatic locking system with a releasing means protruding one end; said housing has a side, top, bottom, back, and a rigid front panel. One end of the cylindrical body is attached permanently unto the bottom panel of the control housing, and the second ending intersected by a pulling means at one side. The “C” hook can be hooked onto a steering wheel, while the telescopic body is manually adjusted, and automatically holds a brake pedal downwards, in order to check a vehicle's brake lights. This device reminds a driver to perform the pre-trip circle checking, but it does this by attaching to the steering wheel, not the rear view mirror.

U.S. Pat. No. 7,808,369 (Brinton) discloses a system and process to ensure performance mandated inspections. The method and apparatus to provide evidence that a person who is intended to make a required inspection was actually physically present at a predefined location associated with the inspection, so that the inspection could have been done, and if not, to provide an indication of the failure to perform the inspection. This invention is particularly well suited to determine if required pre/post-trip inspections of vehicles have been performed. Detecting a triggering condition, such as powering on (or off) equipment, indicates the beginning of a period of time during which the inspection is to be performed. The monitoring system waits for a predetermined event to occur, which indicates the period of time has expired and determines if data corresponding to the inspection have been received. If not, it is concluded that the inspection has not been performed. This device is electronic, and does not involve a mirror cover element.

U.S. Pat. No. 9,478,075 (Toutant) discloses a vehicle safety-inspection apparatus. The vehicle safety-inspection apparatus is for a vehicle having a detectable-identification device fixedly mounted thereto at a predetermined visual inspection point of the vehicle. The vehicle safety-inspection apparatus includes a movable detector configured to detect the presence of the detectable-identification device in response to a user walking around the vehicle and positioning the movable detector proximate to the detectable-identification device during the vehicle safety-inspection of the vehicle. The movable detector is also configured to transmit a detection signal being configured to indicate the presence of the detectable-identification device that was detected. The recording assembly is configured to: (A) receive the detection signal from the detectable-identification device; (B) generate and store a detection-alarm record indicating that the detection signal was received by the recording assembly; and (C) transmit the detection-alarm record that was stored. This device is electronic, and does not involve a mirror cover element.

All documents cited herein are incorporated by reference.

None of the above cited documents, alone or in combination satisfy the need for a compact, portable, non-electronic means of reminding a driver to conduct the mandated vehicle safety checks prior to departure.

### BRIEF SUMMARY

It is an object of the invention to provide a vehicle safety check reminder mirror cover.

In accordance with an aspect of the invention there is provided a cover for a vehicle mirror, the cover comprising: one or more pieces of fabric sized and configured to encompass the vehicle mirror; an opening in the one or more pieces of fabric, sized to allow the vehicle mirror to be inserted into the opening; a visual reminder element to direct the driver to conduct a vehicle check; one or more reflective elements attached to or printed on the one or more pieces of fabric; and a securing mechanism to fasten the cover in place on the vehicle mirror.

The advantages and features of the present invention will become better understood with reference to the following more detailed description and claims taken in conjunction with the accompanying drawings in which like elements are identified with like symbols.

### BRIEF DESCRIPTION OF THE DRAWINGS

To easily identify the discussion of any particular element or act, the most significant digit or digits in a reference number refer to the figure number in which that element is first introduced.

In the figures, embodiments are illustrated by way of example. It is to be expressly understood that the description and figures are only for the purpose of illustration and as an aid to understanding.

Embodiments will now be described, by way of example only, with reference to the attached figures.

FIG. 1A illustrates a front view in accordance with an embodiment of the invention.

FIG. 1B illustrates a rear view in accordance with an embodiment of the invention.

FIG. 2A illustrates a front view of an alternative embodiment of the invention.

FIG. 2B illustrates a front view of an alternative embodiment of the invention.

FIG. 3A illustrates a front view of an additional embodiment of the invention.

FIG. 3B illustrates a front view of an additional embodiment of the invention.

FIG. 4 illustrates a front view of a further embodiment of the invention.

FIG. 5 illustrates a front view of another embodiment of the invention.

FIG. 6 illustrates a front view of yet a further embodiment of the invention.

### DETAILED DESCRIPTION

Devices and methods for carrying out the invention are presented in terms of embodiments depicted within the FIGS. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

Embodiments of this invention as described herein relate to a cover that can be slipped over a mirror of any vehicle. The cover is small, light, compact and easy to carry. The cover acts as a reminder to the driver when they return to the vehicle, that they are required to take action. The cover thereby reminds the driver to complete a circle check of their vehicle to alert them of any potential hazards before backing up or driving away.

Presently most industries/companies require the driver to place a traffic cone at one of the corners of their vehicle. This ensures the driver has to complete a circle check of their vehicle to pick the cone up. Presently the traffic cone is the only physical option to remind the driver to complete this task. Some companies have placed stickers near the door handle on the driver's side of the vehicle to remind the driver. Having to store the cone upon picking it up is often a problem also. Some are large and get in the way. There is also the problem of forgetting the cone is out and just driving away and leaving the cone behind.

The mirror cover or toque can be folded up and put in a pocked or in the console of the vehicle. Anyone travelling from the office can't carry a traffic cone with them. They can put their mirror cover or toque in their purse or jacket pocket. This also solves the problem of borrowing a traffic cone once a driver get to job site. With the mirror cover or toque over one of their mirrors, the driver's attention is immediately triggered Even if a driver initially forgets to circle the vehicle, the mirror cover or toque remains on the vehicle. The first time the driver checks their mirror they will be reminded that they didn't perform the safety check. When they park their vehicle to retrieve the mirror cover or toque they can perform the walk-around safety check.

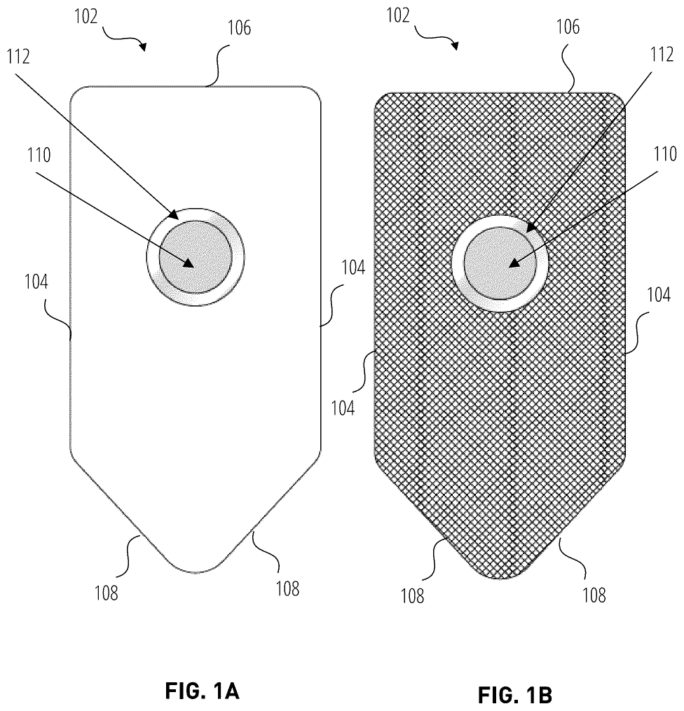

FIG. 1A illustrates a front view of an embodiment of the invention.

FIG. 1A shows a mirror cover 102 having opposing attached sides 104, an attached edge 106 and an open edge 108. A reflective element 110 comprising an optional reminder message 112 is shown on the front surface of the mirror cover 102.

FIG. 1B illustrates a front view of an embodiment of the invention.

FIG. 1B shows a mirror cover 102 having opposing attached sides 104, an attached edge 106 and an open edge 108. A reflective element 110 comprising an optional reminder message 112 is shown on the front surface of the mirror cover 102.

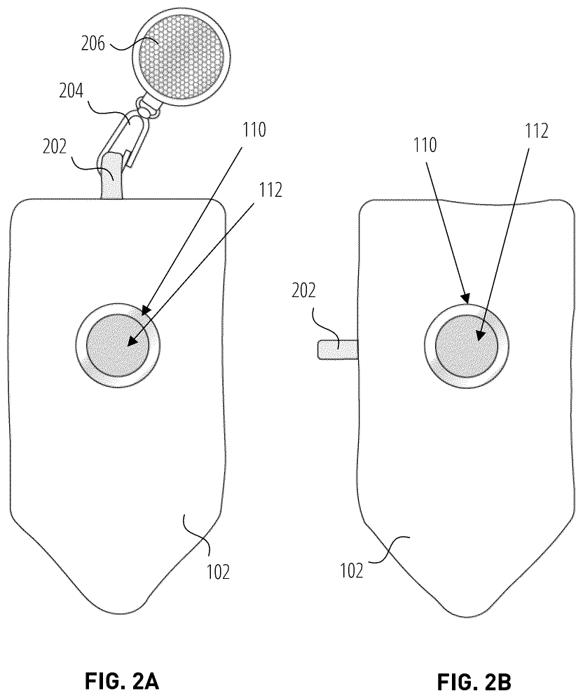

FIG. 2A illustrates a front view of an alternative embodiment of the invention having an edge tab.

FIG. 2A shows a mirror cover 102, comprising a reflective element 110 and reminder message 112 having a different configuration to that illustrated in FIG. 1A and FIG. 1B. The mirror cover 102 additionally comprises a tab 202 attached to the attached edge 106.

In the embodiment illustrated, a detachable light 206, having a clip 204, may be attached to the tab 202. The light 206 may be an individual or dual function flashing or continuous LED light.

FIG. 2B illustrates front view of an alternative embodiment of the invention having a side tab.

FIG. 2B shows a mirror cover 102, comprising a reflective element 110 and reminder message 112 having a different configuration to that illustrated in FIG. 1A and FIG. 1B. The mirror cover 102 additionally comprises a tab 202 attached to one of the attached sides 104. The tab 202 is configured to attach to a light 206 via a clip 204.

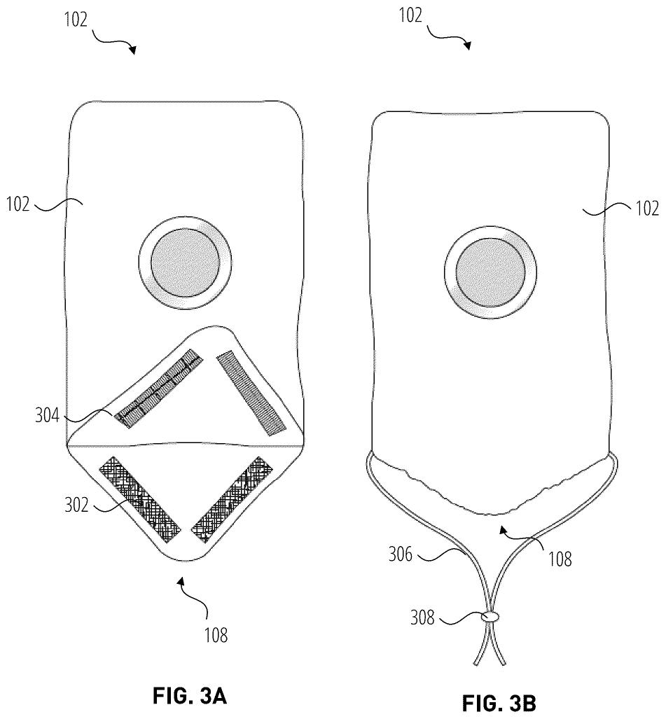

FIG. 3A illustrates front view of an additional embodiment of the invention having a hook and loop fastener.

FIG. 3A shows how the open edge 108 of the mirror cover 102 can be secured onto the side mirror of a vehicle via hook fasteners 304 and cooperating loop fasteners 302.

FIG. 3B illustrates front view of an additional embodiment of the invention having a drawstring and toggle fastener.

FIG. 3B shows how the open edge 108 of the mirror cover 102 can be secured onto the side mirror of a vehicle via a drawstring 306 and toggle 308.

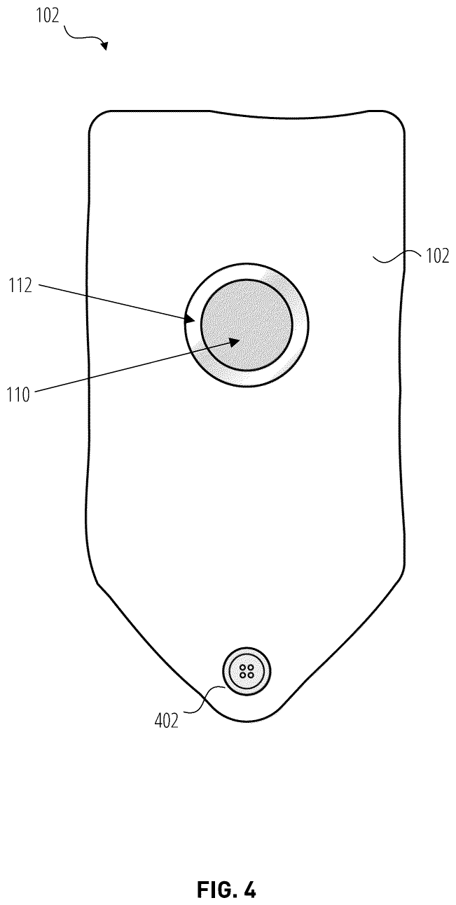

FIG. 4 illustrates a front view of a further embodiment of the invention.

FIG. 4 shows a button 402 situated on the open edges 108 of the mirror cover 102. In some instances the buttons 402, situated on the front and rear sides of the 102 may be decorative. In other embodiments of the invention they may be functional, in that a button 402 is attached to one side and a buttonhole is formed in the other side.

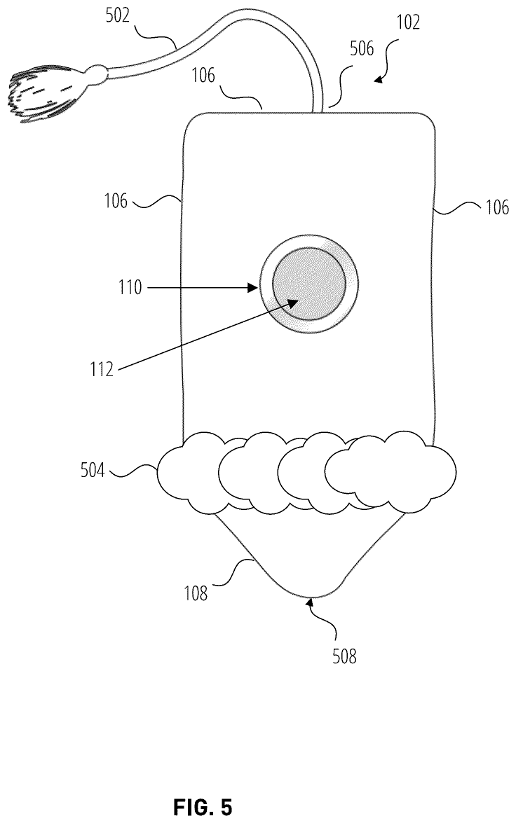

FIG. 5 illustrates a front view of yet a further embodiment of the invention.

FIG. 5 shows how mirror cover 102 can be fabricated to take on the appearance of a toque. When the mirror cover 102 is designed to look like a hat or a toque. A tassel or pom-pom 502 may be placed on the upper attached edge 106 as shown at a point of attachment for tassel or pom-pom 506. Other embodiments may comprise various embellishments 504 such as a pattern, border or fluffy rim that encircles the lower portion of the 102, extending from one attached edge 106 to the other attached edge 106. Yet other embodiments may comprise or more tassels connected to the cover at the alternative point of attachment for one or more tassels 508.

The mirror hat or mirror toque version of the mirror cover 102 can also comprise a tab 202 (not shown) sized and dimensioned to attach to an LED flashing or continuous light 206 via a clip 204. The mirror cover 102 typically also comprises a reflective element 110 and a reminder message 112 on both the front and rear surfaces.

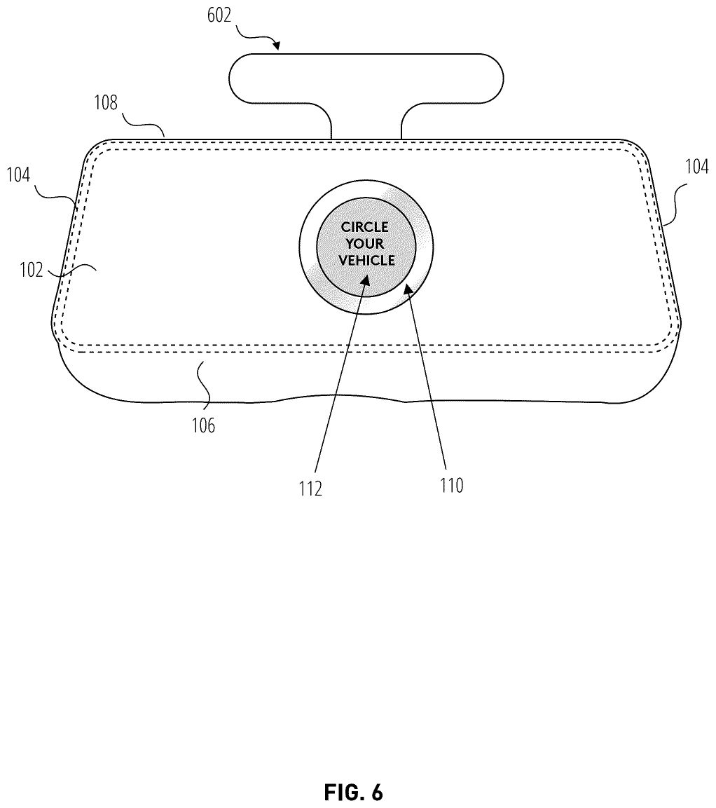

FIG. 6 illustrates a front view of yet a further embodiment of the invention.

FIG. 6 shows that the mirror cover 102 can be configured to fit over the interior rear-view mirror 602. The mirror cover 102 in this embodiment has opposing attached sides 104 and an attached edge 106. The open edge 108 may have an elasticated seam to allow for easy attachment and removal of the mirror cover 102.

In this embodiment, the reminder message 112 may or may not have a reflective element 110.

It is contemplated that the mirror cover 102 is fabricated in a variety of shapes and sizes to accommodate different vehicle mirror shapes and sizes. It is typically made from a stretchy jersey or Spandex-type material. The illustrated embodiments comprise similarly shaped front and rear surfaces that are connected around a majority of their circumference. In an alternative embodiment of the invention, the mirror cover 102 may comprise a single tubular piece of material or fabric.

The advantages of the mirror cover 102 include, but are not limited to: it being impossible to forget to pick up; you can't drive over it; it won't blow away; it won't break if it dropped at −40 C; you can't trip over it; it can be folded up to fit in a jacket pocket or computer bag; it can be customized with company logo; it can be used at home and campground; it is less cumbersome than a traffic cone; it is more environmentally friendly when disposed of; and it is highly visible at all times.

Moreover, when used at night, the glow in the dark logo will help prevent people from walking into the mirror.

The glow-in-the-dark or reflective element 110 can be silkscreen printed onto one or both front and back surfaces of the mirror cover 102. In the alternative, the reflective element 110 may be a patch that is glued or stitched onto the mirror cover 102.

For the non-conventional shaped mirrors, a combination hook fastener 304 and loop fastener 302 can be used to secure the mirror cover 102 to the mirror. Alternatively, a drawstring 306 threaded through a seam and secured in place via a toggle 308 may be used.

In yet another embodiment of the invention, the mirror cover 102 may be applied to the interior rear view mirror 602, typically secured in place via elastic threaded through a seam around the open edge 108 of the mirror cover 102.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. As can be understood, the examples described above are intended to be exemplary only.

The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

The foregoing descriptions of specific embodiments of the present invention have been presented for purposes of illustration and description. They are not intended to be exhaustive or to limit the invention and method of use to the precise forms disclosed. Many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

1. A cover for a vehicle mirror, the cover comprising:
one or more pieces of fabric sized and configured to encompass the vehicle mirror;
an opening in the one or more pieces of fabric, sized to allow the vehicle mirror to be inserted into the opening;
a visual reminder element to direct the driver to conduct a vehicle check;
one or more reflective elements attached to or printed on the one or more pieces of fabric; and
a securing mechanism to fasten the cover in place on the vehicle mirror.

2. The cover of claim 1, wherein the one or more pieces of fabric comprise two similarly shaped pieces of fabric joined around a majority of a circumference of the two similarly shaped pieces of fabric.

3. The cover of claim 1, wherein the one or more pieces of fabric comprise a tubular piece of fabric.

4. The cover of claim 1, wherein the one or more reflective elements are screen printed onto the one or more pieces of fabric.

5. The cover of claim 1, wherein one or more tabs are attached to the one or more pieces of fabric.

6. The cover of claim 5, wherein one or more tabs are connected to an LED light.

7. The cover of claim 6, wherein the LED light is a dual function light having continuous and blinking settings.

8. The cover of claim 1, wherein the securing mechanism is selected from the group comprising: hook and loop fasteners; a drawstring and toggle; or an elasticated seam.

9. The cover of claim 1, wherein the securing mechanism results from having the cover fabricated from a jersey or a Spandex material that is sized to be of similar or smaller dimensions to the vehicle mirror.

10. The cover of claim 1, wherein the cover is sized and configured to accommodate a side mirror.

11. The cover of claim 1, wherein the cover is sized and configured to accommodate an interior rear-view mirror.

12. The cover of claim 1, wherein the visual reminder element comprises a reminder message.

13. The cover of claim 12, wherein the reminder message is printed onto the one or more pieces of fabric.

14. The cover of claim 13, wherein the reminder message is printed proximate to the reflective element.

15. The cover of claim 1, wherein the cover is decorated to have the appearance of a hat or toque, the decorations being selected from a tassel or pom-pom attached to an upper region of the cover.

16. The cover of claim 1, wherein the cover is decorated to have the appearance of a hat or toque, the decorations being selected from one or more buttons attached to a lower surface of the cover.

17. The cover of claim 1, wherein the cover is decorated to have the appearance of a hat or toque, the decorations being selected from a pattern, border or fluffy rim encircling a lower surface of the cover.

18. The cover of claim 1, wherein the cover is decorated to have the appearance of a hat or toque, the decorations being one or more tassels attached to one or more lower regions of the cover.
